(19) United States
(12) Patent Application Publication
(10) Pub. No.: US 2021/0156695 A1
(43) Pub. Date: May 27, 2021

(54) INDOOR NAVIGATION SYSTEM BASED ON AUGMENTED REALITY

(71) Applicant: BEIJING DIDI INFINITY TECHNOLOGY AND DEVELOPMENT CO., LTD., Beijing (CN)

(72) Inventors: Jun Zhang, Beijing (CN); Bin Xu, Beijing (CN); Ronghao Li, Beijing (CN); Xiaoqiang Teng, Beijing (CN); Chao Liu, Beijing (CN); Chong Deng, Beijing (CN); Gengxin Gu, Beijing (CN); Huanqing Zhou, Beijing (CN); Qi Zhou, Beijing (CN); Yue Liu, Beijing (CN); Pengfei Xu, Beijing (CN); Runbo Hu, Beijing (CN); Hongxia Zhang, Beijing (CN); Yingfeng Zhang, Beijing (CN); Guanghui Zhao, Beijing (CN); Bin Du, Beijing (CN); Hua Chai, Beijing (CN); Xian Zhang, Tianjin (CN)

(73) Assignee: BEIJING DIDI INFINITY TECHNOLOGY AND DEVELOPMENT CO., LTD., Beijing (CN)

(21) Appl. No.: 17/169,064

(22) Filed: Feb. 5, 2021

Related U.S. Application Data
(63) Continuation of application No. PCT/CN2018/100899, filed on Aug. 16, 2018.

(51) Int. Cl. G01C 21/20; G06T 19/00

(52) U.S. Cl. CPC G01C 21/206; G06T 19/006

(57) ABSTRACT

Systems and methods for navigating a user to a destination are provided. An exemplary indoor navigation method uses a terminal device. The method includes capturing, by the terminal device, image data of an indoor scene, and determining a current position of the user based on the captured image data. The method also includes determining a navigation path and a navigation sign for navigating the user from the current position to the destination, and rendering, by the terminal device, a three-dimensional representation of the indoor scene with the navigation sign placed therein based on the image data and the navigation path. The navigation sign signals the navigation path in the three-dimensional representation. The method further includes displaying, on the terminal device, the three-dimensional representation to the user.

### CROSS-REFERENCE OF RELATED APPLICATIONS

This application is a bypass continuation of International Application No. PCT/CN2018/100899, entitled “INDOOR NAVIGATION SYSTEM BASED ON AUGMENTED REALITY,” and filed Aug. 16, 2018, the content of which is incorporated by reference in its entirety.

### TECHNICAL FIELD

The present disclosure relates to indoor navigation systems and methods, and more particularly, to indoor navigation systems and methods that render navigation signs in a three-dimensional (3-D) representation of the scene to signal a navigation path to a user.

### BACKGROUND

Navigation systems have been widely used to guide a user to a set destination from his/her current location. Current navigation systems typically use positioning sensors such as a Global Positioning System (GPS) receiver to position the user and determine a path between the user's position and the destination. These navigation systems then display the path, usually highlighted, overlaid with a map to guide the user.

However, the existing navigation systems are not suitable for indoor navigations. For example, a user may be inside a shopping mall trying to find the northeast entrance or section B of the parking garage to meet his rideshare driver. Indoor navigation is challenging because satellite signals are weaker indoor. For example, GPS signals are often weak or even lost when the user is inside a building. GPS also does not provide sufficient positioning precision required by indoor navigation. For example, the precision of GPS positioning is typically on the order of meters. It is oftentimes not precise enough to navigate the user indoor as the pathways are narrow and close to each other.

Unlike maps for driving, indoor maps are usually not available to the user. Therefore, the navigation system cannot overlay a path on the navigation map. In addition, indoor layouts are usually complicated and confusing. For example, in a shopping mall, there can be many pathways and crossroads, and pathways are oftentimes not straight. Using an existing navigation system, the user may still easily get lost.

Embodiments of the present disclosure provide systems and methods that address the aforementioned shortcomings.

### SUMMARY

Embodiments of the disclosure provide an exemplary indoor navigation method for navigating a user to a destination using a terminal device. The method includes capturing, by the terminal device, image data of an indoor scene, and determining a current position of the user based on the captured image data. The method also includes determining a navigation path and a navigation sign for navigating the user from the current position to the destination, and rendering, by the terminal device, a three-dimensional representation of the indoor scene with the navigation sign placed therein based on the image data and the navigation path. The navigation sign signals the navigation path in the three-dimensional representation. The method further includes displaying, on the terminal device, the three-dimensional representation to the user.

Embodiments of the disclosure further provide an indoor navigation system for navigating a user to a destination. The indoor navigation system includes a sensor configured to capture image data of an indoor scene. The indoor navigation system further includes at least one processor configured to determine a current position of the user based on the captured image data, and determine a navigation path and a navigation sign for navigating the user from the current position to the destination. The at least one processor is further configured to render a three-dimensional representation of the indoor scene with the navigation sign placed therein based on the image data and the navigation path. The navigation sign signals the navigation path in the three-dimensional representation. The indoor navigation system also includes a display configured to display the three-dimensional representation to the user.

Embodiments of the disclosure further disclose a non-transitory computer-readable medium. The non-transitory computer-readable medium may store a set of instructions, when executed by at least one processor, cause the at least one processor to perform an indoor navigation method for navigating a user to a destination. The method includes receiving image data of an indoor scene captured by a sensor, and determining a current position of the user based on the captured image data. The method further includes determining a navigation path and a navigation sign for navigating the user from the current position to the destination. The method also includes rendering a three-dimensional representation of the indoor scene with the navigation sign placed therein based on the image data and the navigation path. The navigation sign signals the navigation path in the three-dimensional representation. The method further includes causing to display the three-dimensional representation to the user.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates an exemplary terminal device for navigating a user in an indoor environment, according to embodiments of the disclosure.

FIG. 2 illustrates an exemplary terminal device displaying a three-dimensional representation of an indoor scene and signs, according to embodiments of the disclosure.

FIG. 3 illustrates an exemplary indoor navigation system, according to embodiments of the disclosure.

FIG. 4 shows a flowchart of an exemplary indoor navigation method for navigating a user from a current position to a destination, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

An aspect of the disclosure is directed to an indoor navigation system for navigating a user to a destination (e.g., a building entrance, a parking garage, or a particular room inside the building). The indoor navigation system includes a sensor (e.g., a camera) configured to capture image data of an indoor scene, such as the interior of a shopping mall. The indoor navigation system further includes at least one processor. The at least one processor can be within a terminal device (e.g., a mobile phone, wearable, PDA) carried by the user or within a server. The at least one processor may include multiple processors, some located within the terminal device and some located within the server.

The at least one processor may be configured to determine a current position of the user based on the captured image data. In some embodiments, visual-based positioning methods can be used. In some embodiments, other positioning methods based on, such as GPS signals, Pedestrian Dead Reckoning (PDR) data, wireless network access points, or Bluetooth™ signals, can be used to supplement and improve the positioning accuracy of the user position.

The at least one processor may be further configured to determine a navigation path (e.g., the path from the user's current position and the destination) and a navigation sign for navigating the user from the current position to the destination. In some embodiments, various navigation signs can be used, including, e.g., directional signs, instructional signs, and destination signs. The signs may include graphics and/or texts to signal the navigation path.

The at least one processor may be further configured to render a three-dimensional representation of the indoor scene with the navigation sign placed therein based on the image data and the navigation path. In some embodiments, the rendering may be implemented using Augmented Reality (AR) technologies. The navigation sign may signal the navigation path in the three-dimensional representation. For example, the navigation sign may be an arrow pointing to the direction of the navigation path. In some embodiments, the signs may be rendered floating in the three-dimensional representation. In some embodiments, the signs may be flashing or blinking periodically to catch the user's attention.

The disclosed indoor navigation system may also include a display (e.g., a display device on the terminal device) configured to display the three-dimensional representation to the user. For example, the user might be holding his mobile phone in front of him when walking inside a shopping mall. The mobile phone may show a three-dimensional representation of the indoor scene that the user can see in the real-world, supplemented with the augment reality elements—e.g., superimposing navigation signs—to guide the user according to a navigation path to the destination.

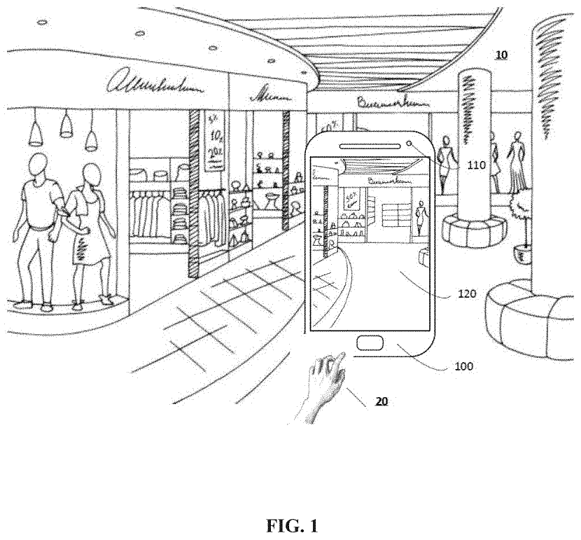

FIG. 1 illustrates an exemplary terminal device 100 for navigating a user 20 in an indoor environment 10, according to embodiments of the disclosure. In some embodiments, indoor environment 10 can be any environment enclosed or partially enclosed by, e.g., walls, roofs, etc. For example, indoor environment 10 may be the inside of a shopping mall, an office building, a school, a convention center, an apartment building, a stadium, a theater, a hotel, etc. Although FIG. 1 illustrates indoor environment 10 as a shopping mall, it is contemplated that the disclosed systems and methods also apply to other types of indoor environment. As shown in FIG. 1, indoor environment 10 may include various store fronts, rest areas, columns, decorations such as plants, and hallways in between. In some embodiments, indoor environment 10 may additionally include escalators, elevators, booths, etc.

User 20 may carry terminal device 100. User 20 may use terminal device 100 for indoor navigation purposes. For example, user 20 may wish to go to a restaurant located in a far end of the shopping mall and use terminal device 100 to navigate to the restaurant. As another example, user 20 may have requested a rideshare transportation service (e.g., DiDi™ service) and need to meet the driver at a particular location, e.g., a mall entrance or a pick-up area in the parking garage. User 20 may use terminal device 100 to guide him to the destination.

Terminal device 100 may include any suitable device that can interact with user 20, e.g., a smart phone, a tablet, a wearable device, a personal digital assistant (PDA), or the like. Terminal device 100 may include, among other components, a camera 110 and a display 120. In some embodiments, camera 110 may be a digital camera built in terminal device 100 and configured to capture photographs and/or record videos. In FIG. 1, camera 110 may be located on the front and/or back surface of terminal device 100. Camera 110 may be configured to capture image data of an indoor scene in indoor environment 10. The image data may include video data. In some embodiments, image data may be saved in the JPEG file format, RAW format, or other static or moving image formats. In some embodiments, the captured image data may be stored locally on terminal device 100, e.g., in a directory called/DCIM in the internal memory. In some embodiments, the captured image data may be stored in an external memory, e.g., a Secure Digital (SD) card or a USB drive. In yet some embodiments, the captured image data may be transmitted to and saved in a remote server or storage. For example, the image data may be transmitted through real-time streaming. The server or remote storage may be located remotely, e.g., in a cloud computing environment.

Display 120 may be mounted on the front side of terminal device 100. In some embodiments, display 120 may be a touch screen capable of receiving user interactions. Display 120 can provide a Graphical User Interface (GUI) for interaction with user. Consistent with the disclosure, display 120 is configured to present a three-dimensional representation of the indoor scene captured by camera 110. The three-dimensional representation is rendered by terminal device 100 to resemble the indoor scene, which is a reflection of the real-world objects.

Consistent with the disclosure, terminal device 100 may additionally render navigation signs, which are presented in the three-dimensional representation displayed by display 120. The navigation signs, individually or collectively, signal a navigation path to guide user 20 from his current position to a predetermined destination. In some embodiments, the navigation path and navigation signs may be determined locally by terminal device 100 or remotely by a server to ensure real-time rendering and display on terminal device 100.

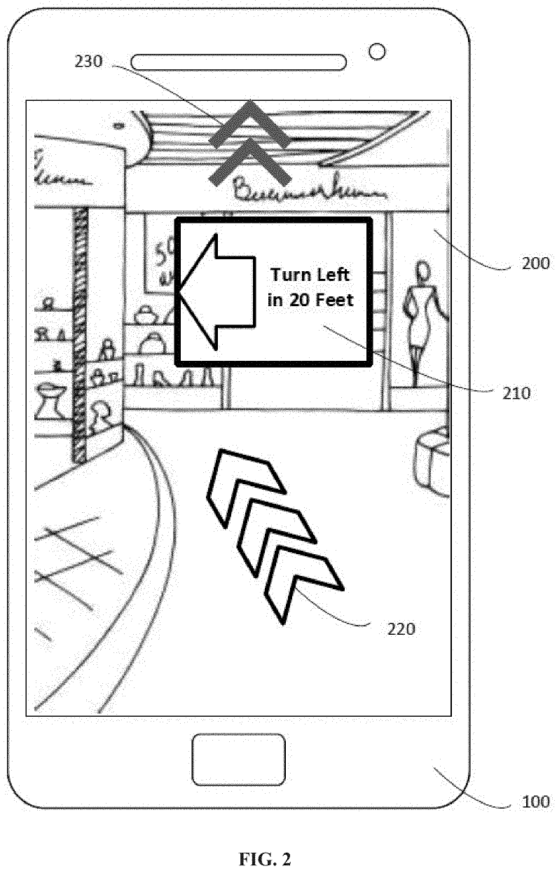

FIG. 2 illustrates an exemplary terminal device 100 displaying a three-dimensional representation 200 of an indoor scene and signs 210-230, according to embodiments of the disclosure. As shown in the example of FIG. 2, three-dimensional representation 200 is rendered to resemble an indoor scene of indoor environment 10, including the various store fronts, the pathway, etc. Navigation signs 210, 220, and instructional sign 230 are rendered in three-dimensional representation 200 to signal a navigation path.

Various navigation signs may be used. For example, navigation sign 210 may be a floating sign that floats in three-dimensional representation 200. A floating sign is “floating” in three-dimensional representation 200 without being attached or embedded to any real-world object. For example, a floating sign can be presented in the center of display 120 and visually “in front of” user 20 to attract the user's attention. In the example shown by FIG. 2, navigation sign 210 includes graphics that illustratively signal the direction user 20 should follow. For example, navigation sign 210 includes an arrow pointing to the left, suggesting that user 20 should turn left behind the store on the left. Navigation sign 210 additionally includes texts, e.g., “turn left in 20 feet” to more explicitly instruct user 20 about the turn and provide detailed information such as the distance (e.g., 20 feet) before user 20 should make the turn. Because the layout of indoor environment 10 is usually complicated and confusing, arrows alone may not be sufficient for user 20 to understand where exactly he needs to turn. Texts provide the additional clarity to guide user 20.

Navigation sign 220 may be a directional sign designed to interactively usher user 20 along the navigation path. In some embodiments, navigation sign 220 may be presented as lights projected on the floor. Navigation sign 220 may be in any suitable shape to indicate the direction and path user 20 should follow. For example, navigation sign 220 may include an arrow, or a group of arrows, pointing in the direction of the navigation path. In some embodiments, navigation sign 220 may progressively move forward as user 20 moves on the navigation path, such that navigation sign 220 is always ahead of user 20. Consistent with some embodiments of the disclosure, terminal device 100 may transform the position of user 20 in indoor environment 10 into the coordinate of three-dimensional representation 200, and always place navigation sign 220 a predetermined distance ahead of the user's position. For example, when navigation sign 220 includes a group of arrows, the last arrow (the arrow at the end of the group closest to the user) may disappear in every few seconds, and a new arrow will be added in the front (the end of the group farthest from the user) around the same time.

Navigation signs may additionally include a destination sign (not shown) rendered and displayed when user 20 arrives at the destination. In some embodiments, the destination sign can be displayed on display 120 when user 20 is sufficiently close to or approaching the destination, for example, when the destination is within the real-world scene user 20 can visually see. The destination sign can likewise include graphics (e.g., an arrow or a pin) and/or texts (e.g., “destination,” “arrived”) to indicate the position of the destination.

Terminal device 100 may also render and display instruction sign 230 that instructs user 20 to adjust the pose of terminal device 100. Because the positioning of user 20 is based on the image data captured by camera 110, it is important that the captured image data contain sufficient features that can be matched with existing images of the scene. Terminal device 100, or the remote server, whichever is performing the positioning operations, can adaptively determine whether terminal device 100 is in the best pose to capture images. For example, user 20 may keep his head down and therefore holding terminal device 100 substantially parallel to the floor. As a result, the image data captured contain mostly images of the floor that lack sufficient features. As another example, user 20 may hold terminal device 100 to point to the right while the navigation path he needs to follow points towards the left. As a result, navigation signs, e.g., 210 and 220, can not be properly displayed. In these cases, terminal device 100 may determine that the pose of terminal device 100 should be adjusted and render instructional sign 230 to interact with user 20. For example, as shown FIG. 2, instructional sign 230 includes arrows pointing up, instructing user 20 to turn the top of terminal device 100 towards himself. By using instruction sign 230, the disclosed navigation system is able to adaptively and dynamically adjust the pose of terminal device 100 to improve the quality of image data captured.

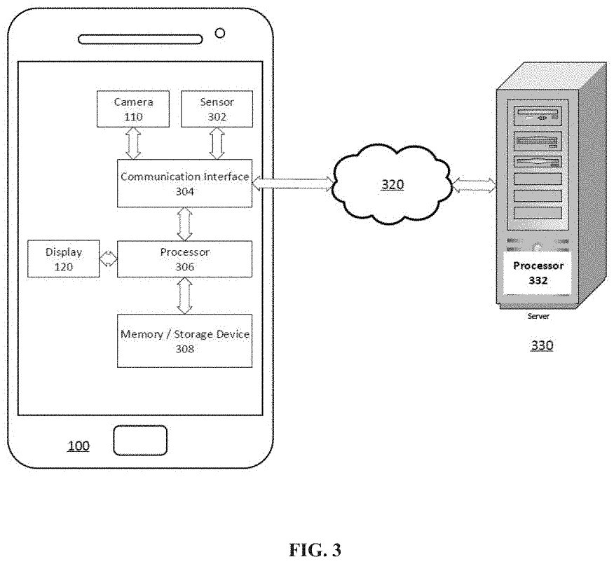

FIG. 3 illustrates an exemplary indoor navigation system, according to embodiments of the disclosure. In some embodiments, the indoor navigation system includes terminal device 100 and a server 330, communicating with each other through a network 320. Network 320 can be a Wireless Local Area Network (WLAN), a Wide Area Network (WAN), wireless networks such as radio waves, a cellular network, a satellite communication network, and/or a local or short-range wireless network (e.g., Bluetooth™).

In some embodiments, as shown in FIG. 3, terminal device 100 may include a camera 110, a display 120, one or more sensors 302, a communication interface 304, a processor 306, and a memory/storage device 308.

In some embodiments, camera 110 may be a digital camera built in terminal device 100 and configured to capture photographs and/or record videos. Camera 110 may include CMOS or CCD image sensors. In some embodiments, camera 110 may use digital zoom or optical zoom. In some embodiments, terminal device 100 may include a menu choice on its display 120 to start a camera application program and an on-screen button to activate the shutter of camera 110. In some embodiments, camera 110 and/or terminal device 100 may have a separate camera button to activate and operate camera 110. In some embodiments, camera 110 may be an external camera coupled wirelessly to terminal device 100 by a communication network, e.g., a WLAN network.

Display 120 may be a Liquid Crystal Display (LCD), a Light Emitting Diode Display (LED), a plasma display, or any other type of display, mounted on the front side of terminal device 100. In some embodiments, display 120 may be a Thin-Film-Transistor (TFT) LCD display or an In-Plane-Switching (IPS) LCD display. The display may include a number of different types of materials, such as plastic or glass, and may be touch-sensitive to receive commands from the user. For example, the display may include a touch-sensitive material that is substantially rigid, such as Gorilla Glass™, or substantially pliable, such as Willow Glass™.

In some embodiments, one or more sensors 302 may include a GPS receiver and/or an Inertial Measurement Unit (IMU) sensor. A GPS is a global navigation satellite system that provides geolocation and time information to a GPS receiver. An IMU is an electronic device that measures and provides a vehicle's specific force, angular rate, and sometimes the magnetic field surrounding the vehicle, using various inertial sensors, such as accelerometers and gyroscopes, sometimes also magnetometers. The GPS receiver and/or the IMU sensor can capture real-time pose data of terminal device 100 as it travels along the navigation path with user 20. The pose data may be used as supplemental information to aid the positioning of user 20/terminal device 100.

One or more sensors 302 may also include sensors that capture lights, radio waves, magnetic fields, acoustic signals, or other sensory information to aid indoor positioning. Base on the captured sensory information, user 20/terminal device 100 can be positioned in indoor environment 10. Such techniques may include, for example, distance measurement to nearby anchor nodes (nodes with known fixed positions, e.g. Wi-Fi/Li-Fi access points or Bluetooth™ beacons), magnetic positioning, and dead reckoning, etc. These techniques either actively locate mobile devices and tags or provide ambient location or environmental context for devices to get sensed.

For example, one or more sensors 302 may include a MEMS inertial sensor configured to capture PDR data. In navigation, dead reckoning is the process of calculating one's current position by using a previously determined position, or fix, and advancing that position based upon known or estimated speeds over elapsed time and course. In some other embodiments, one or more sensors 302 may also include Wi-Fi signal receivers configured to capture Wi-Fi signals. Based on the intensity of the received signal, the Wi-Fi access points can be positioned using fingerprinting methods.

In some embodiments, these various positioning techniques may be used to estimate the user position separately from the visual-based positioning method based on the captured image data, and the estimation result may be used to validate or modify the positioning result obtained by the visual-based positioning method. In some alternative embodiments, these positioning techniques may be performed in conjunction with the visual-based positioning method as constraints or as features to improve the positioning results.

Communication interface 304 can be an integrated services digital network (ISDN) card, cable modem, satellite modem, or a modem to provide a data communication connection. As another example, communication interface 304 can be a local area network (LAN) card to provide a data communication connection to a compatible LAN. Wireless links can also be implemented by communication interface 304. In such an implementation, communication interface 304 can send and receive electrical, electromagnetic or optical signals that carry digital data streams representing various types of information via network 320.

Communication interface 304 may be configured to send the image data captured by terminal device 100 to server 330, and receive determined positions of user 20/terminal device 100 from server 330. Communication interface 304 may also receive data related to navigation signs and instructional signs for rendering by terminal device 100. In some embodiments, communication interface 304 may be configured to receive other data such as user inputs provided through display 120 or other user interface of terminal device 100.

Processor 306 may include any appropriate type of general-purpose or special-purpose microprocessor, digital signal processor, or microcontroller. In some embodiments, processor 306 may include a Graphic Processing Unit (GPU) for image rendering operations. A GPU is a purpose-built device able to assist a CPU in performing complex rendering calculations. Processor 306 may be configured as a separate processor module dedicated to implement the indoor navigation methods disclosed herein. Alternatively, processor 306 may be configured as a shared processor module for performing other functions unrelated to providing transportation service. Processor 306 may include one or more hardware units (e.g., portions of an integrated circuit) designed for use with other components or to execute a part of a program. The program may be stored on a computer-readable medium, and when executed by processor 306, it may perform one or more functions. In some embodiments, the program may include ARKit™ developed for AR rendering.

In some embodiments, processor 306 may be configured to render a three-dimensional representation, such as 200, for display on display 120. 3-D rendering is the automatic process of generating a photorealistic or non-photorealistic image from a 3-D model (also known as a scene file) by means of computer programs. A scene file contains objects in a strictly defined language or data structure, which may contain geometry, viewpoint, texture, lighting, and shading information as a description of the virtual scene. Processor 306 may execute a rendering program to process the data contained in the scene file output to a digital image or raster graphics image file, which can be displayed by display 120.

Consistent with the present disclosure, processor 306 may also render and place the navigation signs (such as navigation signs 210 and 220) and instructional signs (such as instructional sign 230) in the three-dimensional representation. In some embodiments, AR techniques may be used for rendering the signs. AR is an interactive experience of a real-world environment whereby the objects that reside in the real-world are “augmented” by computer-generated perceptual information, sometimes across multiple sensory modalities, including visual, auditory, haptic, somatosensory, and olfactory. The overlaid sensory information can be constructive (i.e. additive to the natural environment) or destructive (i.e. masking of the natural environment) and is seamlessly interwoven with the physical world such that it is perceived as an immersive aspect of the real environment. In this way, augmented reality alters one's ongoing perception of a real-world environment. In the present disclosure, the navigation signs and instructional signs are overlaid with the 3-D representation of the real-world indoor scene to navigate user 20 to a destination.

To render and position the navigation signs, processor 306 may use data received from server 330, and transform the data into the coordinate system of the three-dimensional representation. For example, based on the position of user 20/terminal device 100 in indoor environment 10, processor 306 may determine the coordinates corresponding to that position in the coordinate system of the three-dimensional representation. Processor 306 then determines the positions of the signs in the three-dimensional representation relative to the user position, and according to the navigation path received from server 330. In other words, the signs may be positioned at cross-points of the navigation path and boundary surfaces at a predetermined distance away from the user position. In some embodiments, processor 306 may also render a destination sign when it is detected that user 20 has arrived at the destination. Processor 306 may determine the coordinates corresponding to the destination in the coordinate system of the three-dimensional representation, and place the destination sign at the coordinates.

Consistent with some embodiments, processor 306 may continuously update the three-dimensional representation and signs in real-time as user 20 moves around in indoor environment. For example, processor 306 may include different information in the signs based on the updated location of user 20 and the navigation path. Processor 306 may also re-position the signs according to the navigation path and keep it at a predetermined distance away from the user's position in the three-dimensional representation. That way, user 20 may see updated signs in front of him to provide continuous navigation.

Memory/storage device 308 may include any appropriate type of mass storage provided to store any type of information that processor 306 may need to operate. Memory/storage device 308 may be volatile or non-volatile, magnetic, semiconductor-based, tape-based, optical, removable, non-removable, or other type of storage device or tangible (i.e., non-transitory) computer-readable medium including, but not limited to, a ROM, a flash memory, a dynamic RAM, and a static RAM. Memory/storage device 308 may be configured to store one or more computer programs that may be executed by processor 306 to perform indoor navigation disclosed herein. For example, memory/storage device 308 may be configured to store program(s) that may be executed by processor 306 to determine suitable pick-up locations for the passenger.

Memory/storage device 308 may be further configured to store information and data used by processor 306. For instance, memory/storage device 308 may be configured to store the various types of data captured by camera 110 and/or sensors 302 (e.g., image data, sensory data, etc.) and received from server 330 (e.g., the navigation path, data related to the navigation signs and instructional signs). Memory/storage device 308 may also store intermediate data such as data created during the rendering process. The various types of data may be stored permanently, removed periodically, or disregarded immediately after each frame of data is processed.

Server 330 can be a general-purpose server or a proprietary device specially designed for indoor navigation. It is contemplated that, server 330 can be a stand-alone system (e.g., a server) or an integrated component of a stand-alone server. In some embodiments, server 330 may have different modules in a single device, such as an integrated circuit (IC) chip (implemented as an application-specific integrated circuit (ASIC) or a field-programmable gate array (FPGA)), or separate devices with dedicated functions. In some embodiments, one or more components of server 330 may be located in a cloud, or may be alternatively in a single location or distributed locations. Components of server 330 may be in an integrated device, or distributed at different locations but communicate with each other through network 320 or other types of communication links.

In some embodiments, server 330 may include components similar to those described above in terminal device 100, such as a communication interface (not shown), a processor 332, and a memory/storage device (not shown). The communication interface may be configured in a manner similar to communication interface 304, to facilitate communications between terminal device 100 and server 330. Processor 332 may have similar hardware structures as processor 306. For example, processor 332 may include one or more hardware units (e.g., portions of an integrated circuit) designed for use with other components or to execute a part of a program. The program may be stored on a computer-readable medium (e.g., the memory/storage device), and when executed by processor 332, it may perform one or more functions. The memory/storage device may also have similar structures as memory/storage device 308.

Because processing image data and perform positioning operations in real-time using visual-based positioning methods may require significant computation resources, the indoor navigation system may be preferably implemented to have such processing performed by server 330, which typically has more computational capacities. However, it is contemplated that some or all of such processing may be performed locally by processor 306 of terminal device 100.

In some embodiments, processor 332 may perform visual-based positioning methods to position user 20/terminal device 100 based on the image data captured by terminal device 100. For example, processor 332 may compare pre-existing image data stored at server 330 with the captured image data. More specifically, processor 3329 may perform feature matching methods to match the captured image data with pre-existing image data taken from known locations in the indoor environment. For example, pre-existing image data may be images of a shopping mall taken from known locations. In some embodiments, methods such as Visual Simultaneous Localization and Mapping (vSLAM) may be implemented for locating user 20/terminal device 100.

Processor 332 may be additionally configured to determine the navigation path to guide user 20 from his current position to the destination. In some embodiments, the navigation path can be determined according to preset criteria, such as shortest distance, shortest time, least turns, avoid stairs, etc. Determining the navigation path may include deeming the coordinates of points on the navigation path.

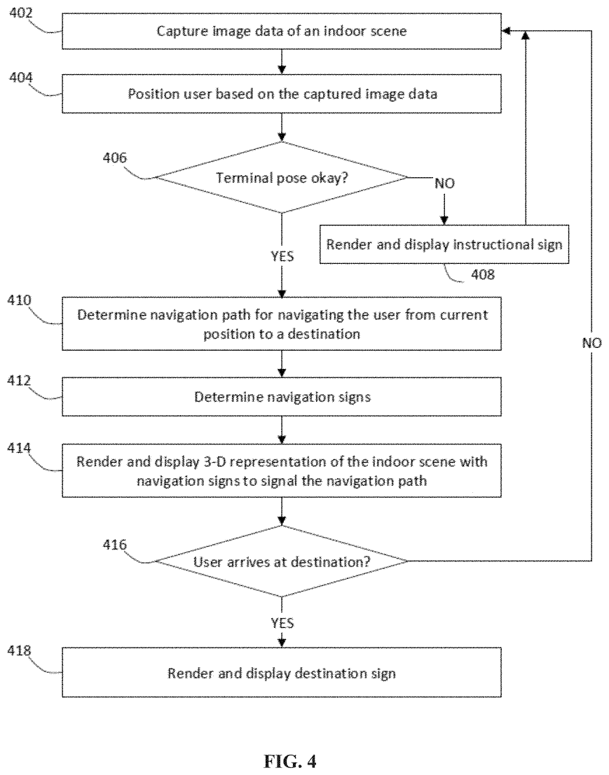

FIG. 4 shows a flowchart of an exemplary indoor navigation method 400 for navigating a user from a current position to a destination, according to embodiments of the disclosure. Method 400 may be implemented by terminal device 100 and/or server 330, each including at least one processor. In the description below, the combination of terminal device 100 and server 330 is used as an example for implementing method 400. It is contemplated that method 400 can also be implemented entirely by terminal device 100. Consistent with the present disclosure, method 400 navigates the user in an indoor environment by showing the user a three-dimensional representation of the real-world scene overlaid by various navigation signs that signal the navigation path the user needs to follow to get to the destination. Method 400 may include several steps as described below, some of which may be optional.

In step 402, camera 110 may capture image data of an indoor scene. For example, user 20 may hold terminal device 100 in front of him and camera 110 mounted on terminal device 100 may automatically and continuously capture images of indoor environment 10. In some embodiments, the captured image data may be transmitted to server 330 from terminal device 100.

In step 404, server 330 may position user 20 based on the captured image data. Since user 20 usually holds terminal device 100, user 20 may be positioned by positioning terminal device 100. In the present disclosure, the position of user 20 is considered equivalent to the position of terminal device 100. In some embodiments, visual-based positioning methods, such as vSLAM, may be used to position user 20. For example, server 330 may compare the captured image data with pre-existing image data taken of indoor environment 10 from know locations. A position may be determined for user 20 that provides the best matching of image features between the captured image data and the pre-existing image data.

In some embodiments, in step 406, server 330 may determine if the pose of terminal device 100 is appropriate. In some embodiments, server 330 may make such a determination during the positioning process using the captured image data, e.g., as in step 404. For example, if the captured image data contains insufficient features (such as intensity variation, objects, textures) for accurately positioning user 20, server 330 may determine that the pose of terminal device 100 should be adjusted. Pose adjustment may include adjusting the orientation, the vertical upper angle, the height of terminal device 100, etc.

If the pose is not appropriate (step 406: no), server 330 may additionally determine an optimal pose for terminal device 100 for the purpose of capturing image data with more useful information. The optimal pose may be provided to terminal device 100, e.g., via network 320. In step 408, terminal device 100 may render and display an instructional sign, e.g., 230, according to the optimal pose. For example, terminal device 100 may compare its current pose with the optimal pose to determine what actions user 20 needs to take in order to adjust terminal device 100 to the optimal pose. Accordingly, the instructional sign is created to instruct user 20 to take such actions. For example, instructional sign 230 may include arrows pointing to the top of display 120, instructing user 20 to turn the top of terminal device 100 close to himself in order to make terminal device 100 more vertical. Once user 20 follows the instruction sign displayed in step 408, method 400 may return to step 402 to re-capture the image data at the better pose.

If the pose is appropriate (step 406: yes), method 400 proceeds to step 410. In step 410, server 330 may determine a navigation path between the current position of user 20, as determined in step 404, and a preset destination. For example, user 20 may want to get to a place to meet his rideshare driver right outside a shopping mall or in the parking garage. Accordingly, the meeting place is his destination, and the navigation path is the route he needs to take indoor in order to get to the destination.

In step 412, server 330 may additionally determine navigation signs, in order to guide user 20 to follow the navigation path. In some embodiments, the navigation signs may include directional signs that use graphics (such as arrows) and/or texts to signal the navigation path, such as to make a turn, to go straight ahead, or to go up/down an escalator. The content of a navigation sign is dynamically determined based on the user's position on or relative to the navigation path. The navigation signs indicate the next steps user 20 needs to follow in order to get to the destination.

The navigation path and navigation signs, if determined by server 330, may be provided to terminal device 100, e.g., via network 320. In step 414, terminal device 100 may render and display a three-dimensional representation (e.g., 200) of the indoor scene captured by camera 110 as the image data. For example, 3-D rendering methods may be used to create a scene file. Consistent with the present disclosure, terminal device 100 may additionally render and overlay navigation signs with the three-dimensional representation. In some embodiments, AR techniques may be used for rendering the signs, e.g., through using an ARKit™.

Various navigation signs may be rendered in step 414, including, e.g., navigation signs 210 and 220 shown in FIG. 2. For example, the navigation signs may include a floating sign, e.g., 210, that floats in the three-dimensional representation. Consistent with some embodiments, the navigation signs may include graphics such as an arrow pointing to a direction to intuitively signal the navigation path to the user. The navigation signs may alternatively or additionally include texts, e.g., “go straight for 20 feet” to explicitly instruct user 20. In some embodiments, the navigation signs may include a combination of graphics and texts for better clarity. For example, navigation sign 210 may include both an arrow pointing to the left and the texts “turn left in 20 feet” to direct user 20 to make a left turn in 20 feet.

As another example, the navigation signs may also include a directional sign, e.g., 220, to direct user 20 to follow the navigation path. In some embodiments, navigation sign 220 may be presented as lights projected on the floor, to indicate the direction and path user 20 should follow. For example, navigation sign 220 may include an arrow, or a group of arrows, pointing in the direction of the navigation path, and progressively move forward as user 20 moves on the navigation path.

Consistent with some embodiments of the disclosure, terminal device 100 may place the navigation signs on the navigation path at a predetermined distance in front of user 20. To do so, terminal device 100 may first transform the position of user 20 in indoor environment 10 into the coordinate of the three-dimensional representation, and then from a boundary surface that is the predetermined distance away from that user position. For example, the boundary surface may be a cylindrical surface formed using the user's position as the center and using the predetermined distance as the radius. The position of the navigation sign is then determined as a cross-point of the boundary surface and the navigation path.

Terminal device 100 may render the navigation signs to signal the navigation path in various ways. For example, a directional sign can include a group of arrows, the last arrow (the arrow at the end of the group closest to the user) may disappear in every few seconds, and a new arrow will be added in the front (the end of the group farthest from the user) around the same time. Alternatively or additionally, elements of the navigations signs may flash, blink, or otherwise vary in intensity, color, format, etc. For example, a floating sign may blink at a frequency close to a heartbeat rate. In some embodiments, a sign may blink at a high frequency when user 20 gets close to a turning point.

The position of user 20 may be continuously monitored and tracked. In step 416, server 330/terminal device 100 may determine if user 20 has arrived at the destination or is approaching the destination. If so (step 416: yes), terminal device 100 renders and displays a destination sign in the three-dimensional representation, to indicate the destination to user 20.

Otherwise (step 416: no), method 400 returns to step 402 to capture the next set of image data and repeats steps 402-418 to update the three-dimensional representation and the navigation signs and instructional sign, as user 20 moves along the navigation path. In some embodiments, the update occurs continuously, dynamically, and in real-time. In particular, the position of the navigation sign may be updated and repositioned as described in connection with step 410. In some embodiments, the updated position of the navigation sign may be always at the predetermined distance away from the user's updated position.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. An indoor navigation method for navigating a user to a destination using a terminal device, comprising:
capturing, by the terminal device, image data of an indoor scene;
determining a current position of the user based on the captured image data;
determining a navigation path and a navigation sign for navigating the user from the current position to the destination;
rendering, by the terminal device, a three-dimensional representation of the indoor scene with the navigation sign placed therein based on the image data and the navigation path, wherein the navigation sign signals the navigation path in the three-dimensional representation; and
displaying, on the terminal device, the three-dimensional representation to the user.

2. The indoor navigation method of claim 1, wherein the navigation sign includes a directional sign pointing the user in a direction according to the navigation path.

3. The indoor navigation method of claim 1, wherein the navigation sign includes text information instructing the user to move in a direction according to the navigation path.

4. The indoor navigation method of claim 1, wherein the navigation sign floats in the three-dimensional representation.

5. The indoor navigation method of claim 1, wherein rendering the three-dimensional representation further comprises:
determining a first position in the three-dimensional representation corresponding to the current position of the user in the indoor scene; and
placing the navigation sign at a second position in the three-dimensional representation, wherein the second position is a predetermined distance away from the first position.

6. The indoor navigation method of claim 5, further comprising:
updating the three-dimensional representation as the user moves to a new position in the indoor scene;
determining a third position in the updated three-dimensional representation corresponding to the new position of the user; and
placing the navigation sign at a fourth position in the updated three-dimensional representation, wherein the fourth position is the predetermined distance away from the third position.

7. The indoor navigation method of claim 1, further comprising:
detecting that the user has arrived at the destination;
rendering a destination sign in the three-dimensional representation; and
displaying the destination sign on the terminal device.

8. The indoor navigation method of claim 1, wherein determining the current position of the user based on the captured image data further comprises comparing the captured image data with pre-existing image data of the indoor scene.

9. The indoor navigation method of claim 1, further comprising capturing Pedestrian Dead Reckoning data,
wherein determining the current position of the user is further based on the Pedestrian Dead Reckoning data.

10. The indoor navigation method of claim 1, further comprising rendering an instructional sign in the three-dimensional representation, wherein the instructional sign instructs the user to adjust a pose of the terminal device.

11. An indoor navigation system for navigating a user to a destination, comprising:
a sensor configured to capture image data of an indoor scene; and
at least one processor configured to:
determine a current position of the user based on the captured image data;
determine a navigation path and a navigation sign for navigating the user from the current position to the destination; and
render a three-dimensional representation of the indoor scene with the navigation sign placed therein based on the image data and the navigation path, wherein the navigation sign signals the navigation path in the three-dimensional representation; and
a display configured to display the three-dimensional representation to the user.

12. The indoor navigation system of claim 11, wherein the navigation sign includes a directional sign pointing the user in a direction according to the navigation path.

13. The indoor navigation system of claim 11, wherein the navigation sign includes text information instructing the user to move in a direction according to the navigation path.

14. The indoor navigation system of claim 11, wherein the navigation sign floats in the three-dimensional representation.

15. The indoor navigation system of claim 11, wherein to render the three-dimensional representation, the at least one processor is further configured to:
determine a first position in the three-dimensional representation corresponding to the current position of the user in the indoor scene; and
place the navigation sign at a second position in the three-dimensional representation, wherein the second position is a predetermined distance away from the first position.

16. The indoor navigation system of claim 15, wherein the at least one processor is further configured to:
update the three-dimensional representation as the user moves to a new position in the indoor scene;
determine a third position in the updated three-dimensional representation corresponding to the new position of the user; and
place the navigation sign at a fourth position in the updated three-dimensional representation, wherein the fourth position is the predetermined distance away from the third position.

17. The indoor navigation system of claim 11, wherein the at least one processor is further configured to:
detect that the user has arrived at the destination;
render a destination sign in the three-dimensional representation; and
display the destination sign on the display.

18. The indoor navigation system of claim 11, further comprising an inertial sensor configured to capture Pedestrian Dead Reckoning data,
wherein at least one processor is configured to determine the current position of the user further based on the Pedestrian Dead Reckoning data.

19. The indoor navigation system of claim 11, wherein at least one processor is further configured to render an instructional sign in the three-dimensional representation, wherein the instructional sign instructs the user to adjust a pose of a terminal device comprising the sensor.

20. A non-transitory computer-readable medium that stores a set of instructions, when executed by at least one processor, cause the at least one processor to perform an indoor navigation method for navigating a user to a destination, the method comprising:
receiving image data of an indoor scene captured by a sensor;
determining a current position of the user based on the captured image data;
determining a navigation path and a navigation sign for navigating the user from the current position to the destination;
rendering a three-dimensional representation of the indoor scene with the navigation sign placed therein based on the image data and the navigation path, wherein the navigation sign signals the navigation path in the three-dimensional representation; and
causing to display the three-dimensional representation to the user.
